(19) United States
(12) Patent Application Publication
(10) Pub. No.: US 2002/0050704 A1
(43) Pub. Date: May 2, 2002

(54) Module cover of airbag device

(76) Inventor: Kazuhiro Abe, Echigawa (JP)

Correspondence Address: KANESAKA AND TAKEUCHI, 1423 Powhatan Street, Alexandria, VA, 22314, US

(21) Appl. No.: 09/984,644

(22) Filed: Oct. 30, 2001

(30) Foreign Application Priority Data
Nov. 2, 2000 (JP) 2000-336335

(51) Int. Cl. B60R 21/16

(52) U.S. Cl. 280/743.1; 280/728.1

(57) ABSTRACT

A module cover of an airbag device for a driver's seat is formed of a module cover member having a pair of longitudinal tear lines which when the module cover member is mounted on a steering wheel extend in up and down directions, and a transverse tear line which interconnects the longitudinal tear lines, and an emblem formed separately from the module cover member and attached on a surface of the module cover member to face a driver. At least a part of the transverse tear line is located at a side above the emblem. Thus, it is possible to eliminate scoring of the module cover which tends to occur when the module cover is subjected to an external force.

### BACKGROUND OF THE INVENTION AND RELATED ART STATEMENT

The present invention relates to a module cover of an airbag device, and more particularly, to a module cover having a module cover member provided with tear lines for allowing the module cover member to be torn and an emblem.

A known airbag device for a driver's seat and a module cover thereof, will be described with reference to FIGS. 3 to 5, by way of example.

Referring to FIG. 3, an airbag device 11 for a driver's seat of a vehicle is installed on a central portion of a steering wheel 10 of the vehicle. The airbag device 11 has a mount plate generally referred to as a “retainer” to which an inflator and an airbag are secured, and a module cover member 12 covers the inflator and the airbag. As shown in FIGS. 4 and 5, the module cover member 12 has fitting portions 14 formed in the side wall portions thereof and adapted to fit on spokes 13 of the steering wheel 10.

The module cover member 12 is made of a synthetic resin, with or without a reinforcement, such as a mesh, embedded therein. The module cover member 12 is provided with tear lines which facilitate tearing of the module cover member when the airbag device is activated.

The tear lines include a pair of longitudinal tear lines 16 extending along left and right side edges of the module cover member 12 (more precisely, extending from a front and upper end portion to a rear and lower end portion as viewed in the direction of a chassis of a vehicle), and a transverse tear line 17 which extends transversely, i.e. in the width direction of the vehicle at a central region of the module cover member 12, so as to interconnect the longitudinal tear lines 16. In the specification, terms indicating directions with respect to the vehicle chassis, such as height direction, longitudinal direction and width direction, are used in the context that the steering wheel is kept at a neutral position to allow the vehicle run straightforward.

The tear lines are, for example, continuous grooves or perforations formed along the lines at which the module cover member is to be torn. When the continuous grooves are used, the depth of the grooves may be partly varied. The module cover member may be formed of a laminate of two layers, one is rigid while the other is soft. In such a case, slits may be formed in the rigid layer along the expected tear lines, thus serving as the tear lines.

Upon collision of the vehicle mounting this airbag device, the inflator (gas generator) is activated to inflate the airbag, so that the module cover member 12 is torn first along the transverse tear line 17. The tear then propagates to the longitudinal tear lines 16, so that the module cover member 12 is torn as indicated by arrows with two-dot-and-dash lines in FIG. 3, whereby the airbag expands into the compartment.

A decorative plate usually referred to as an “emblem” is formed separately from the module cover member 12 for the driver's seat and attached thereto. A structure is known in which an emblem fitting recess is formed in the surface of the module cover member facing the driver, so as to receive the emblem therein, as disclosed, for example, in Japanese Patent Publications (KOKAI) No. 10-273004 and No. 11-189119.

FIG. 5 shows an emblem fitting structure disclosed in Japanese Patent Publication No. 10-273004. A module cover member 21 has a cover portion 22 which covers a boss of a steering wheel where the airbag is housed and spokes of the steering wheel, and a mounting tubular portion protruding downward from the rear surface of the cover portion 22 and having a polygonal cross-sectional shape. The cover portion 22 has a pair of longitudinal tear lines 24b and a transverse tear line 24a which interconnects the longitudinal tear lines 24b. Rivet holes 23a are formed in the mounting wall portion 23, so as to enable the cover member to be secured to the retainer of the airbag device.

An emblem-fitting recess 28 for receiving an emblem is formed substantially at the center of the cover portion 22 of the module cover member 21, and a piece of an emblem 31 is fitted in the recess 28. The recess 28 is penetrated at its center by a rivet hole 28b and is provided with a plurality of slits 28c formed along the periphery thereof.

The emblem 31 has a plurality of legs 32c extending rearward therefrom. A hole 32d is formed in a free end portion of each leg 32c.

The emblem 31 is fitted in the recess 28 such that the legs 32c extend through the slits 28c. The legs 32c are then bent inward so that their ends are superposed respectively such that the holes 32d of these legs 32c are aligned concentrically. Then, a rivet 33 is driven through the aligned holes 32d of the legs 32c and through the rivet hole 28b of the recess 28, so that the emblem 31 is fixed to the module cover member 21.

As will be seen from FIG. 5, the transverse tear line 24 is formed to extend at the lower side of the emblem 31.

Due to a reason of attractiveness, it is common for the emblem 31 to be disposed substantially at the center or slightly above the center of the surface of the module cover member 21 facing the driver, as shown in FIG. 5. This naturally leads to an arrangement in which the transverse tear line 24a extends substantially at the center or slightly below the center of the module cover member 21.

An airbag device having the module cover member 21 with the transverse tear line 24a thus positioned suffers from a problem such that the module cover member 21 when pressed deflects significantly along the transverse tear line 24a, which is likely to form a score along this line due to concentration of the stress thereto.

This problem of scoring along the transverse tear line is serious particularly when the airbag device is provided with a horn switch, because in such a case, the airbag device (module cover) is pressed frequently.

Accordingly, an object of the present invention is to eliminate the risk of scoring as described above.

### SUMMARY OF THE INVENTION

In accordance with the present invention, there is provided a module cover of an airbag device for a driver's seat, comprising a module cover member having a pair of longitudinal tear lines which when the module cover member is mounted on a steering wheel extend in the up and down directions and a transverse tear line which interconnects the longitudinal tear lines. The module cover member further includes an emblem which is formed separately from and provided on the module cover member at the surface of the module cover member facing a driver, wherein at least a part of the transverse tear line is located at a side above the emblem.

The airbag module cover having the described features effectively suppresses the scoring tendency of the module cover member, by virtue of the fact that the transverse tear line is formed at the side above the emblem where the stress is less likely to concentrate.

### BRIEF DESCRIPTION OF THE DRAWINGS

FIG. 1(a) is a perspective view of a module cover of an airbag device in accordance with an embodiment of the present invention, and FIG. 1(b) is a sectional view taken along line 1(b)-1(b) of FIG. 1(a);

FIGS. 2(a) and 2(b) are sectional views showing deformation conditions of the module cover;

FIG. 3 is a perspective view of a steering wheel with an airbag device having a conventional module cover;

FIG. 4 is a perspective view of a conventional module cover;

FIG. 5 is an exploded perspective view of a conventional module cover;

FIG. 6 is a perspective view of a module cover embodying the present invention;

FIG. 7 is a perspective view of a module cover embodying the present invention;

FIG. 8 is a perspective view of a module cover embodying the present invention; and

FIG. 9 is a perspective view of a module cover embodying the present invention.

### DETAILED DESCRIPTION OF PREFERRED EMBODIMENTS

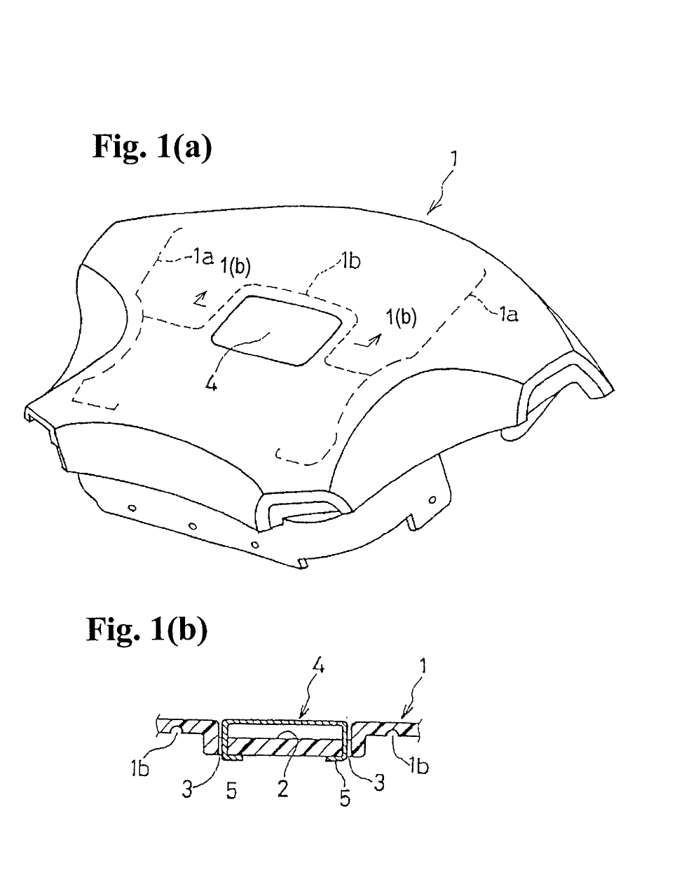

Embodiments of the present invention will be described with reference to the accompanying drawings. FIG. 1(a) is a perspective view of a module cover member of an airbag device embodying the present invention, while FIG. 1(b) is a sectional view taken along line 1(b)-1(b) of FIG. 1(a).

The airbag device having this module cover is disposed on a central portion of a steering wheel, as in the conventional airbag devices. The module cover has a module cover member 1 which is formed by, for example, injection molding from a thermoplastic resin, separately from an emblem 4. The inner surface of the module cover 1 is provided with longitudinal tear lines 1a and a transverse tear line 1b. When the airbag inflates, the module cover member 1 is torn along the tear lines 1a and 1b. A recess 2 for fitting the emblem 4 therein is formed in the front face of the module cover member 1.

In this embodiment, the emblem 4 has a substantially rectangular form and so does the recess 2. Obviously, however, the emblem and the recess may have other suitable contours. Through-holes 3 are formed along the peripheral end, i.e. at the bottom of the step, of the recess 2, so as to receive corresponding legs 5 of the emblem 4, thus fixing the emblem 4 to the module cover member

The emblem 4 has a top wall and side walls extending downward perpendicularly from the periphery of the top wall. The legs 5 are formed at the ends of the side walls so as to project away from the side walls.

In this embodiment, the emblem 4 is formed by a metal sheet work from, for example an aluminum sheet, with the legs 5 formed as thin-walled tongues.

The pair of longitudinal tear lines la extends up and down at both left and right side portions of the module cover member 1, while the transverse tear line 1b is formed so as to interconnect longitudinally intermediate portions of the longitudinal tear lines 1a.

In the embodiment shown in FIGS. 1(a) and 1(b), the emblem 4 is positioned substantially at the center of the surface of the module cover member 1 facing the driver. The transverse tear line 1b has its both ends positioned substantially at the same level as the lower end edge of the emblem 4. Thus, the transverse tear line 1b extends along the upper side and both lateral sides of the emblem 4.

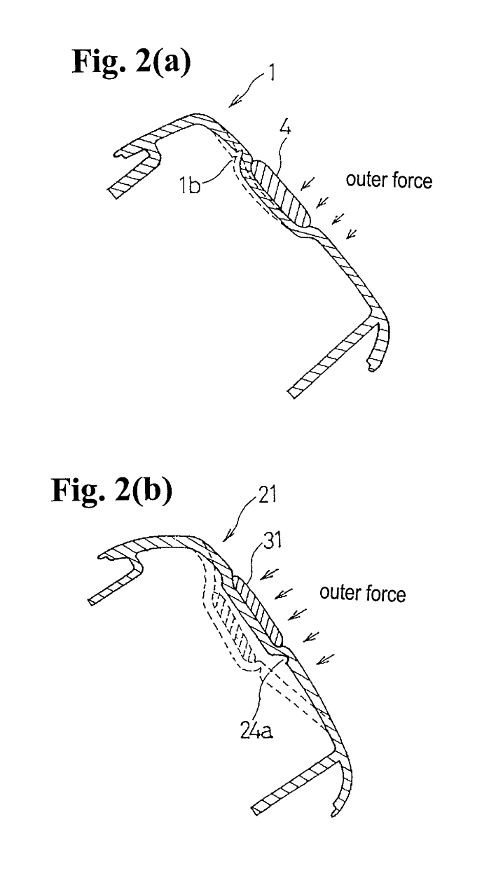

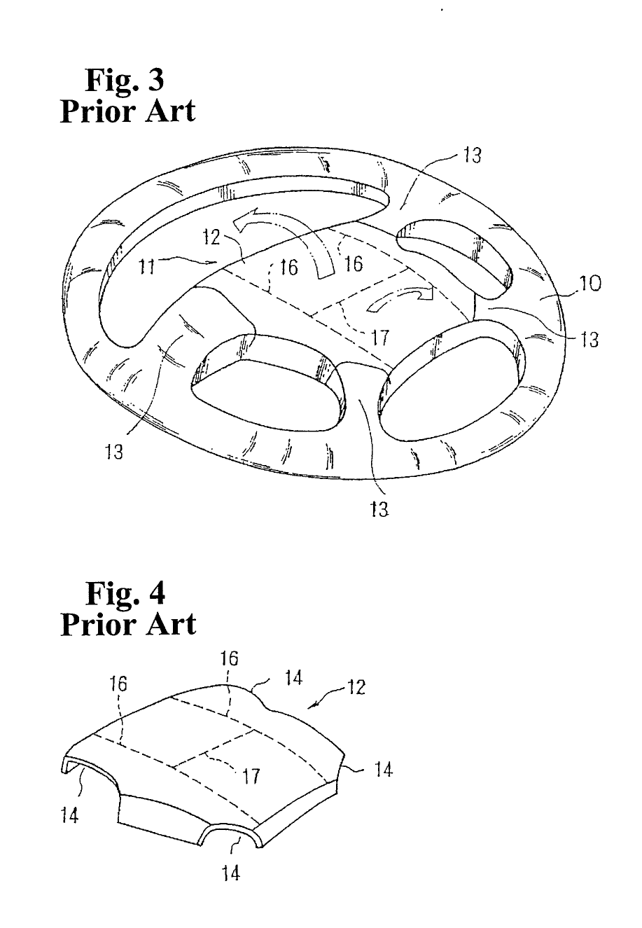

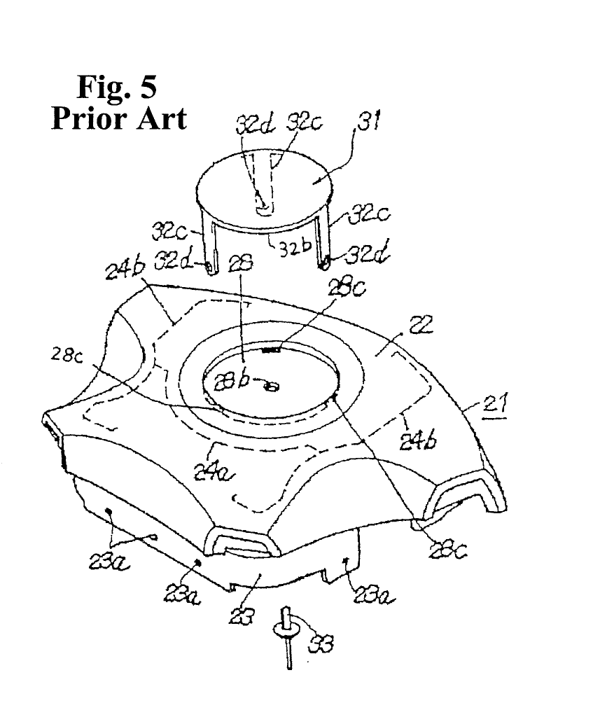

In the module cover member 1 as described, the transverse tear line 1b extends along and above the upper side of the emblem 4, in the lateral central region of the module cover member 1. Thus, the transverse tear line 1b detours around the central portion of the module cover member 1 where the module cover member 1 is most likely to deflect when pressed on its surface facing the driver. Consequently, as shown in FIG. 2(a), the module cover member 1 is subjected to almost no deformation and no score is formed along the transverse tear line 1b, even when the module cover member 1 is deformed by an external force.

The reduced deflection tendency of the module cover member 1 permits the wall thickness of the module cover member 1 to be reduced, thus contributing to reduction in the production cost and weight of the module cover member 1.

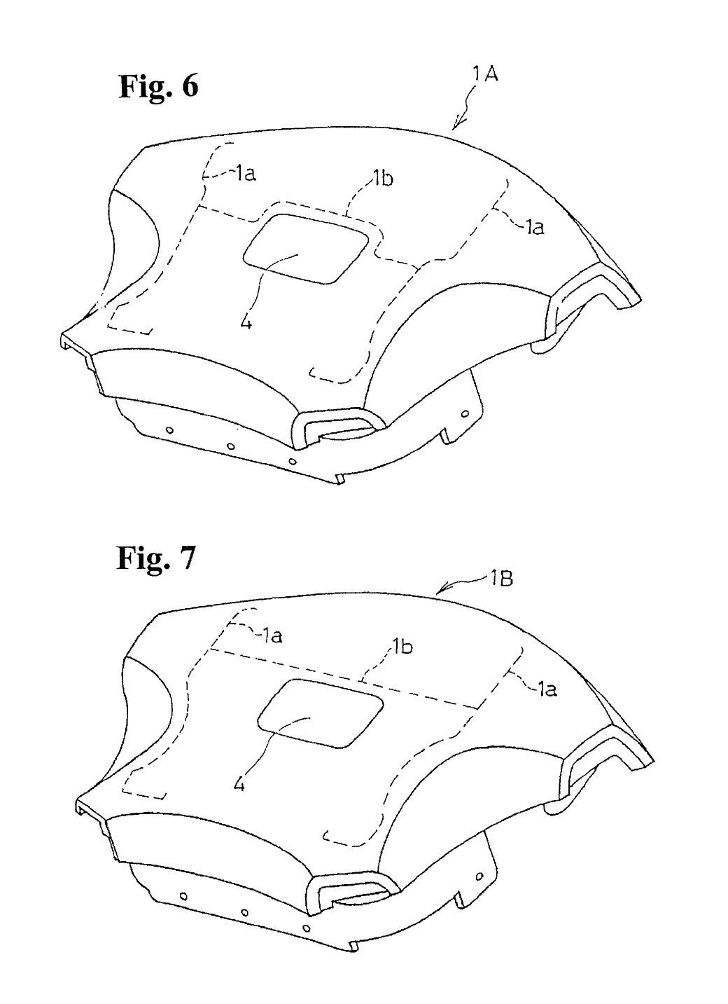

FIGS. 6 to 9 show modifications 1A to 1D of the module cover of the present invention. In each of these modifications, the transverse tear line 1b is positioned above the position shown in FIG. 1(a).

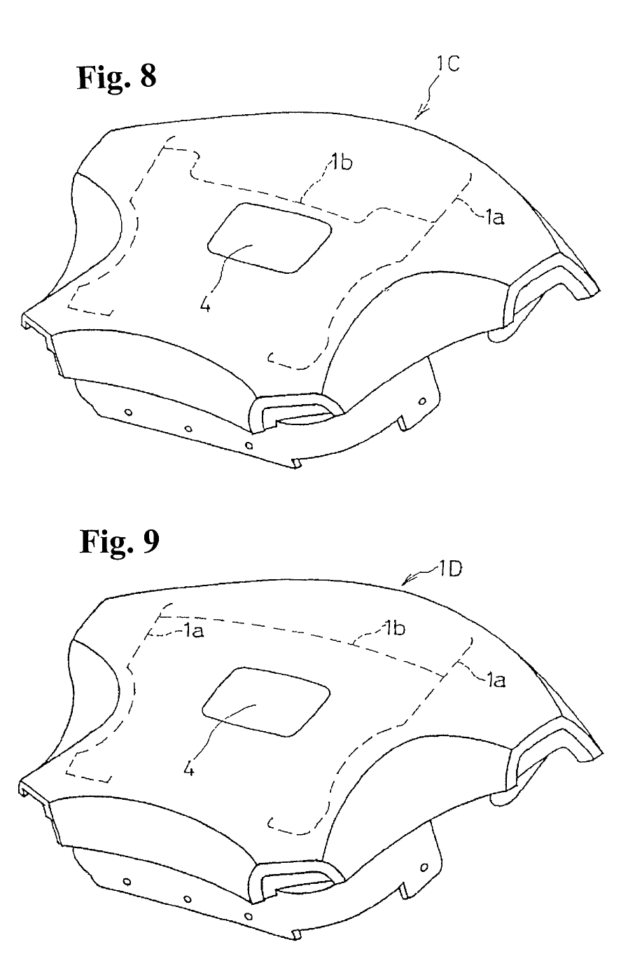

More specifically, FIG. 6 shows a module cover member 1A in which both ends of the transverse tear line 1b are positioned at a level above the level shown in FIG. 1(a). FIG. 7 shows a module cover 1B in which the transverse tear line 1b extends transversely and substantially straight. FIG. 8 shows a module cover member 1C in which both ends of the transverse tear line 1b are positioned at a level above the level of the central portion of the tear line 1b. FIG. 9 shows a module cover 1D in which the entire tear line 1b extends substantially straight at a region near the upper side of the module cover member 1D.

As will be understood from the foregoing description, the airbag module cover in accordance with the present invention exhibits a small deflection when pressed, thus eliminating the risk of scoring. In addition, the invention permits the module cover member to have a smaller thickness than ever.

While the invention has been explained with reference to the specific embodiments of the invention, the explanation is illustrative, and the invention is limited only by the appended claims.

What is claimed is:

1. A module cover of an airbag device for a driver's seat, comprising:
a module cover member having a pair of longitudinal tear lines which when the module cover member is mounted on a steering wheel extends in up and down directions, and a transverse tear line which interconnects the longitudinal tear lines, and
an emblem formed separately from the module cover member and attached on a surface of the module cover member to face a driver,
wherein at least a part of said transverse tear line is located at a side above the emblem.

2. A module cover according to claim 1, wherein said module cover member includes a front surface facing the driver, and a center area of the front surface, said emblem being located at the center area and having upper, lower and two lateral sides.

3. A module cover according to claim 2, wherein said transverse tear line includes two side line portions and a center line portion between the two side line portions, said two side line portions extending substantially perpendicularly to the two lateral sides of the emblem, and said center line portion extending to at least partially surround the upper and two lateral sides of the emblem.

4. A module cover according to claim 2, wherein said transverse tear line extends linearly above the upper side of the emblem.
